(19) United States
(12) Patent Application Publication
(10) Pub. No.: US 2009/0019121 A1
(43) Pub. Date: Jan. 15, 2009

(54) Message processing

(75) Inventor: John Mears, Gloucester (GB)

Correspondence Address: NIXON & VANDERHYE, PC, 901 NORTH GLEBE ROAD, 11TH FLOOR, ARLINGTON, VA, 22203, US

(73) Assignee: MESSAGELABS LIMITED, Gloucester (GB)

(21) Appl. No.: 11/822,873

(22) Filed: Jul. 10, 2007

(51) Int. Cl. G06F 15/16

(52) U.S. Cl. 709/206

(57) ABSTRACT

A message processing system 1 processes messages 5 such as emails being delivered across a network. A plurality of processing modules 10 are each operable to perform an action. A policy engine 11 causes the operation of processing modules 10 selectively in accordance with rules in a rules data store 12 and facts in the fact data store 13. The rules specifying the performance of actions in dependence on facts. The actions performed by the modules 10 include actions of analysing a message 5 and generating message facts specifying information about messages 5, such as the presence of unacceptable content. Thus the rules may specify actions dependant on such message facts. The actions include actions of controlling the delivery of a message 5 or other remedial action.

### BACKGROUND OF THE INVENTION

(1) Field of the Invention

The present invention relates to the processing of messages, for example emails, being delivered across a network. In particular the present invention relates to a message processing system for performing such processing.

(2) Description of Related Art

It is well known to process emails being delivered across a network. The processing is typically to analyse or scan the emails for unacceptable content and to take remedial action when unacceptable content is detected. Although such processing has been applied most extensively to emails, it could equally be considered for other types of message.

In the case of emails, many types of unacceptable content may be detected, including: malware which may for example cause unauthorised use of a recipient's computer system; spam which may be defined as any unsolicited email and which wastes time and resources, particularly in the case of mass-mailed spam; or simply culturally unacceptable content, that is content which a recipient may find undesirable or even offensive, such as pornography or violent content. The unacceptable content may be found in the email itself, for example in the content of an email or may be found in an attachment. A wide variety of techniques are applied to detect the different types of unacceptable content. Such techniques are under continual development.

The remedial action may also take a wide range of forms. One type of remedial action is for a scanning system automatically to prevent, limit or change the delivery of the email. Another type of remedial action is for a scanning system automatically to remove the unacceptable content. Another type of remedial action is to provide feedback that the unacceptable content has been found to allow someone to take action manually.

Due to the huge choice in the types of processing which may be applied, any given scanning system will typically implement a policy of processing emails which involves a complicated combination of the different types of processing available. Such a policy will typically depend on the entity (which may be an individual or an organisation) on whose behalf the processing is performed, for example when the tolerance to different types of unacceptable content differs or when the desired remedial action differs. Typically the email processing system will be implemented by an organisation which processes emails on behalf of different customers. In this case the policy will generally differ as between the customers.

Existing email scanning systems generally implement an email processing policy by hard-coding the processing of emails in the system. For example the different processing may be implemented by use of the Sieve Mail Filtering Language as discussed for example in the website http://sieve.info/. Scripts in accordance with this language may be written to specify the processing which is performed on emails. However hard-coding of the processing, for example using the Sieve Mail Filtering Language, results in a complex system that is hard to modify, especially as the complication of the policy increases and when different policy is implemented on behalf of different entities. Such complexity can in turn potentially lead to a detrimental effect on the actual operation of the scanning system resulting in reduced functionality and/or efficiency. For example, complexity means that the system is inflexible and in practical terms cannot be adapted quickly with the result that it is incapable of dealing with rapidly changing threats.

### BRIEF SUMMARY OF THE INVENTION

According to the present invention, there is provided a message processing system for processing messages being delivered across a network, the system comprising:

a plurality of processing modules which are each operable to perform an action, the actions performed by the modules including actions of controlling the delivery of a message;

a facts data store storing facts including message facts specifying information about messages, the actions performed by the modules further including actions of analysing a message and generating message facts;

a rules data store storing rules, the rules specifying the performance of actions in dependence on facts in the facts data store;

a policy engine operative to cause the operation of processing modules selectively in accordance with rules in the rules data store and facts in the facts data store on which the rules depend.

The message processing system implements a generic technique for the processing of messages in a highly flexible way according to policy and content. In particular, message processing is controlled by a policy engine which has no intrinsic knowledge of the rules or message content. The rules representing the policy in accordance with which messages are processed is stored separately and is combined with currently known facts about the message in question by the generic policy engine to determine the next action to perform.

The rules, and hence the action performed in accordance with the rules, depend on the facts, which include message facts specifying information about messages and generated by modules. Such message facts may also include the extraction of content from a message and may include analysis of a message to identify unacceptable content. Hence the policy engine does not need any intrinsic knowledge of messages or of the analysis of messages, this knowledge instead being contained in the modules which generate message facts and in the rules.

The policy engine causes actions to be performed on a message by causing the operation of modules. As well as the generation of message facts, the actions include actions of controlling the delivery of a message and may include other remedial actions such as modifying a message to remove unacceptable content and providing feedback of message facts.

The main advantages are flexibility and simplicity. A wide range of different functionality can be implemented by incorporating a corresponding range of different processing modules providing different actions to be performed. Complex sequences of message processing using the actions performed by the modules can be specified in a simple way in the rules in dependence on the message facts.

The separation of knowledge about policy from the engine that implements it allows functionality and policy to be modified very easily without extensive redesign of the message processing system. In particular such modification may be implemented simply by modifying the processing modules and/or the rules.

Thus there are advantages in the development and maintenance of the message scanning system. In practical terms this means that the system can be adapted more quickly and better. As a result the system is better able to deal with rapidly changing threats.

The message scanning system has particular application to messages which are emails, but is equally applicable to any other type of message beign delivered across a network, for example an IM message or a web page.

### BRIEF DESCRIPTION OF THE DRAWINGS

FIG. 1 is a diagram of the message scanning system at a node of a network; and

FIG. 2 is a diagram of the structure of the message scanning system itself.

### DETAILED DESCRIPTION OF THE INVENTION

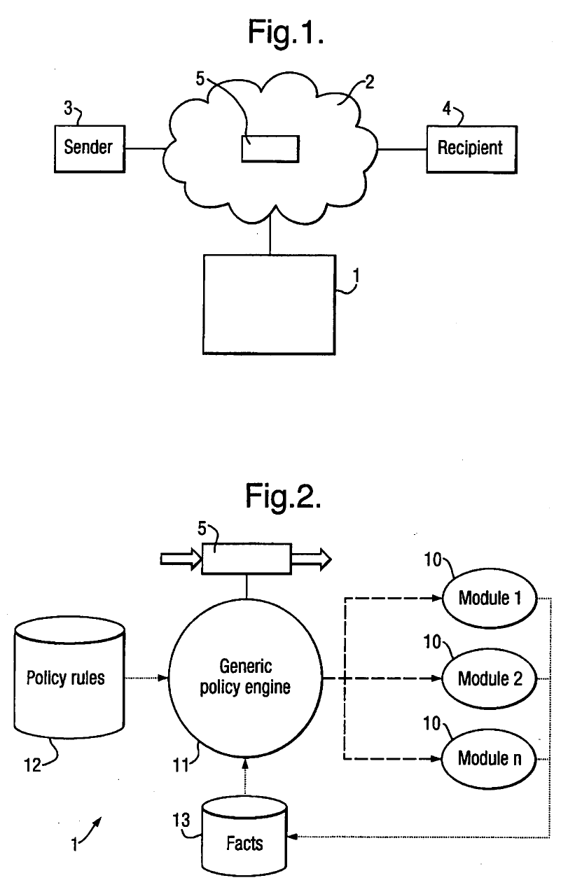

FIG. 1 shows a message processing system 1 at a node of a network 2 which is typically the internet, but may in principle be any other form of network. The message processing system 1 processes messages 5 which are delivered over the network 2 from the computer of a sender 3 to the computer of a recipient 4.

There will first be described an example in which the message 5 is an email. In this case, the message 5 may be transferred using any suitable protocol including, but not limited to: end-to-end SMTP, IMAP4 and UCCP. Any messages 5 to be processed on behalf of an entity, for example all messages sent by the entity and/or all messages 5 received by the entity, are routed through the message processing system 1. The message processing system 1 may typically process messages 5 on behalf of multiple entities in accordance with different policies. Those entities may be, for example, the sender's organisation, a recipient's organisation, smaller groups/departments within the organisations, the individual user, and the organisation running the message processing system 1. Such entities may be customers of the organisation running the message processing system 1.

The message processing system 1 is arranged as shown in FIG. 2 to process respective messages 5 and may be implemented by a suitable computer system.

The message processing system 1 performs a series of actions on respective messages 5 in a generic way.

The message processing system 1 includes a plurality of processing modules 10. Each processing module 10 performs a respective action. The action may be have a range of complexity from a simple single step to multiple complex steps. The actions performed by processing modules 10 include actions performed on a message 5 but also include other actions of generating facts as described below. The processing modules 10 may be implemented in software. However for some actions, the processing modules 10 may consist of or include hardware. This is particularly advantageous for actions involving analysing malware for unacceptable content such as malware where the analysis uses a technique susceptible to a hardware-based solution.

The processing modules 10 are caused to operate by a generic policy engine 11. The policy engine 11 selects processing modules 10 in accordance with rules stored in a rules data store 12 and also in dependence on facts stored in a facts data store 13. The policy engine 11 controls which processing modules 10 operate and in which order, as well as the respective messages 5 on which the processing modules 10 operate.

The policy engine 10 manages the processing modules 10 to maximise the efficiency of their use. The processing modules 10 may operate in parallel and independently in which case the policy engine 10 may cause plural processing modules 10 to operate simultaneously, on the same or different messages 5. However as discussed below the operation of some processing modules 10 are interdependent and the policy engine 11 takes this into account in selecting processing modules 10 to operate.

The policy engine 10 is implemented in software. In one implementation, the policy engine 10 may be implemented using the logic programming language Prolog which is advantageous because it has good support for deducing outcomes from rules. However in general any other suitable implementation could be used. The rules stored in the rules data store 12 and the facts stored in the facts data store 13 are represented by data structures in a suitable format to be interpreted by the policy engine 10. The data stores 12 and 13 are therefore simply memory storing the rules and facts in that format. The data stores 12 and 13 could in principle be as databases implemented by a database application but this is not necessary.

The actions which may be performed on a message 5 by respective processing modules 10 will now be considered and include the following.

One type of action which may be performed on a message 5 is to analyse the message 5 and generate a fact (or plural facts) which is a message fact specifying information about the message 5. The generated message fact is stored in the facts data store 13 by the module. The information may take various forms.

In the simplest case, the information may be content extracted from the message 5, typically from the header of the message 5. This information may include any or all of the fields of the header, for example a recipient, the sender, the subject, the sending time stamp, the receiving time stamps of all intermediate and final mail transfer agents.

Other types of information include: the size of the message 5; information about the message content, for example particular words or phrases; information about the existence or nature of attachments; and/or information about the transmission of the message 5, for example the sending server or details of the transmission protocol.

Another important type of information is the existence or nature of unacceptable content. In this case, the action performed by the processing module 10 concerned is to analyse the message 5 for the unacceptable content. The unacceptable content may be of any type including but not limited to: malware which may for example cause unauthorised use of a recipient's computer system; spam which may be defined as any unsolicited message, although mass-mailed spam is of particular concern; confidential information; or simply culturally unacceptable content, that is content which a recipient may find undesirable or even offensive. The processing module 10 may analyse the message 5 itself for unacceptable content for example the message content or the email header being formatted in a way causing misoperation of software which processes the message 5. Alternatively the processing module 10 may analyse any attachments of the message 5.

Another alternative is the existence or nature of content that is of interest, although not unacceptable as such.

In overview any suitable analysis technique may be applied. Indeed it is advantageous for the message processing system 1 to include a range of processing modules 10 which perform as many different types of analysis as possible to maximise functionality.

Another type of action which may be performed on a message 5 is to control the delivery of the message 5. The control of delivery may occur in any manner. One action which a processing module may perform is to allow the message 5 to pass through the system 1. This may involve the processing module 10 itself delivering the message 5 onwards or may involve the processing module 10 passing the message 5 to another system which performs the delivery.

Another possible action is to control the delivery by modifying the message 5, before it is allowed to pass the system 1. This may be done to limit or change or re-route the delivery, for example by change of the recipient list in the email header. By way of example, the message 5 may be instead delivered to an administrator or to a quarantine storage from where a recipient and/or sender can release it.

Alternatively, an action of controlling the delivery may involve preventing delivery of the message 5 altogether, for example by deleting it or by directing it to a quarantine store.

Another way in which the delivery may be controlled is for the processing module 1 to perform an action of sending control data in respect of the message 5 to a separate system which performs the actual delivery of the message 5 in accordance with that control data.

Such control of the delivery are examples of remedial action which it is desired to perform when a message 5 contains unacceptable content. Other actions which may be performed on a message 5 are other remedial actions.

One possible remedial action is to modify the message 5, for example to remove unacceptable content, to change the subject, to remove an attachment or to change a link contained in the message 5.

Another possible remedial action is to provide feedback that the unacceptable content has been found. This allows a person to take note of the unacceptable content and manually to take whatever action they deem fit. This may be someone responsible for the message processing system 1 or someone on whose behalf the processing is performed. One example is for the feedback to be provided by logging data of message facts such as the presence and nature of unacceptable content. One example is for the feedback to be provided by the action being to generate a new email containing such an email fact, for example to be sent to a recipient and/or sender of the message 5 being processed.

In overview any suitable remedial action may be included. Indeed it is advantageous for the message processing system 1 to include a range of processing modules 10 which perform as many different types of remedial action as possible to maximise functionality.

New functionality may be provided to the message processing system 1 simply by the introduction of new processing modules 10 to perform new actions. In this way the message processing system 1 may be updated, for example to take advantage of new analysis techniques. It is a particular advantage that this may be achieved without the need to recode the policy engine 10.

Respective processing modules 10 may also perform actions to generate module facts relating to the processing modules 10 present. The generated module fact is stored in the facts data store 13 by the module. The module facts are described further below.

The facts in the facts data store 13 will now be considered.

The facts include the message facts specifying information about respective messages 5 being processed and the module facts relating to the processing modules 10 present.

The message facts are generated by particular processing modules 10 which analyse the respective messages 5, as described above. The nature of such message facts is also described with reference to the actions. Thus message facts are generated dynamically as the message processing system 1 processes new messages 5.

The module facts include module facts which identify the actions performed by respective processing modules 10. In this way the capabilities of the processing modules 10 are described by the facts. For example, a module fact might identify that a particular processing module 10 performs an action of analysing a message 5 to identify a particular type of unacceptable content. This provides a layer of abstraction between the policy engine 11 and the processing modules 10, so that the policy engine 10 does not need intrinsic knowledge of the actions performed by the processing modules. Instead the policy engine 10 selects an action to be performed and causes operation of the processing module 10 identified by a module fact to perform that selected action.

The module facts also include module facts which specify the dependencies of the actions performed by different processing modules 10. Such module facts might specify that a particular module requires other modules to have been operated previously. This allows a complicated set of actions to be built up using the actions of individual processing modules 10 as building blocks. For example if a first processing module 10 performs an action of extracting certain message content to generate a message fact, a second processing module 10 may perform an action of analysing that extracted message content. In that case the action of the second processing module 10 is dependent on the action of the first processing module 10. The policy engine 11 takes such module facts into account in selecting the operation of processing modules 10.

As described above the module facts are generated by the processing modules 10 although this is not essential as the module facts could instead be generated by the developer of the system 1. The module facts are typically stored in the facts data store 13 prior to the processing of messages 5, but again this is not essential.

The rules in the rules data store 12 will now be considered.

The rules specify the performance of actions in dependence on facts in the facts data store 13. The rules effectively express the policy about what actions to perform in given situations. The rules may be conditional.

As the rules are dependant on facts which include message facts specifying information about messages 5, in effect the rules may be made dependent on that information about messages 5. In this way, some rules may specify the performance of actions which are remedial in dependence on message facts specifying information about a message 5 that the message 5 contains unacceptable content. Other rules may specify the performance of other actions which are dependant on message facts specifying other information about a message 5, for example that an action of compressing a message 5 should be performed if the message 5 is of a certain size.

To allow the policy to vary for different customers, the actions should differ for different customers. In practical terms, this may be achieved by use of rules which specify the performance of actions which differ in the case of message facts specifying different delivery attributes, for example a recipient and/or sender of the message 5.

As previously mentioned, the policy engine 11 selects processing modules 10 in accordance with the facts and rules. The policy engine 11 may use all current rules and facts to make the selection. For example, where a module fact specifies a dependency between the actions performed by different processing modules 10, the policy engine 11 will cause operation of the processing modules 10 concerned in an order which conforms with the specified dependancy. Similarly where a rule is dependant on a particular message fact about a message 5, the policy engine 11 will cause operation of the processing module 10 which generates that message fact.

However the selection may be based solely on those facts and rules. Thus the policy engine 10 contains no knowledge other than facts and rules. In particular the policy engine 10 contains no intrinsic knowledge of the messages 5, their content or the actions that might be performed on them. The benefit of this approach is the rules and the policy engine 10 are separated. This allows the complicated policies, which may differ for different customers, to be easily implemented and changed, simply by changing the rules. For example merely by selection of appropriate rules different customers can receive different types of analysis of messages for unacceptable content and different types of remedial action where unacceptable content is detected. Such advantages in the development and maintenance of the message scanning system 1 mean that in practical terms the message scanning system 1 can be adapted more quickly and better. As a result the message scanning system 1 is better able to deal with rapidly changing threats.

By way of illustration, there will now be described some specific examples of particular sets of rules and facts which may be employed in the message scanning system 1. In these examples, the initial facts arise from the processing modules 10 that are installed. Further facts are added as processing modules 10 are invoked by the policy engine 11. In this example, the various actions, facts and rules are expressed linguistically, but of course they are represented in the message processing system 1 by appropriate data structures capable of interpretation by the policy engine 11.

### FIRST EXAMPLE

### Processing Modules 10:

virus scanner module, which performs a scan action of scanning a file for a virus;
delivery module, which performs a deliver action of delivering a message 5; and
splitter module, which performs an action of splitting an attachment from a message 5.

### Initial Facts:

1: the delivery module can perform the deliver action;
2: the virus scanner module can perform the scan action; and
3: the virus scanner module requires the attachment splitter module to be run first.

### Rules:

1: if no virus is present in an attachment to a message 5, then deliver the message.

When the message processing system 1 receives a message 5 having attachments which are clean of any virus, this causes the following sequence of operation:

Policy engine 11 analyses the rules and facts, and infers that the splitter module must be run.

Policy engine 11 runs the splitter module. This creates new facts: a list of the attachments found in the message 5. The attachments themselves are written to temporary storage.

Policy engine 11 analyses the rules and facts, and infers that the virus scanner module must be run.

Policy engine 11 runs the virus scanner module. This analyses the attachments in temporary storage. The virus scanner finds no virus and does not generate any facts.

Policy engine 11 applies rule 1 and infers that the deliver action must be performed.

Policy engine 11 runs the deliver module to deliver the message 5.

Policy engine 11 finds that no more rules match, and terminates.

When the message processing system 1 receives a message 5 having an attachment which contains a virus, this causes the following sequence of operation:

Policy engine 11 analyses the rules and facts, and infers that the splitter module must be run.

Policy engine 11 runs the splitter module. This creates new facts: a list of the attachments found in the message 5. The attachments themselves are written to temporary storage.

Policy engine 11 analyses the rules and facts, and infers that the virus scanner module must be run.

Policy engine 11 runs the virus scanner module. This analyses the attachments in temporary storage. The virus scanner module finds a virus and generates a fact accordingly.

Policy engine 11 finds that no more rules match, and terminates. As a result the message 5 is not delivered to its recipient and has been blocked.

As an alternative to the above, the message processing system 1 could be configured as a default to deliver a message 5 when processing has been terminated but to include a blocking module which performs an action of preventing delivery of a message 5, with appropriate rules.

### SECOND EXAMPLE

### Processing Modules 10:

as first example, plus:
logging module, which performs a log action of logging data; and
notification module, which performs a notifying action of notifying the sender and an administrator by sending an email.

### Initial Facts:

Initial Facts 1 to 3 as first example, plus:
Initial Fact 4: the logging module can perform the log action; and
Initial Fact 5: the notification module can perform the notification action.

### Rules:

Rule 1 as first example, plus:
Rule 2: if a virus is present is present in an attachment to a message 5, then perform the log action; and
Rule 3: if a virus is present is present in an attachment to a message 5, then perform the notification action.

When the message processing system 1 receives a message 5 having an attachment which contains a virus, this causes the following sequence of operation:

Policy engine 11 analyses the rules and facts, and infers that the splitter module must be run.

Policy engine 11 runs the splitter module. This creates new facts: a list of the attachments found in the message 5. The attachments themselves are written to temporary storage.

Policy engine 11 analyses the rules and facts, and infers that the virus scanner module must be run.

Policy engine 11 runs the virus scanner module. This analyses the attachments in temporary storage. The virus scanner module finds a virus and generates a fact accordingly.

Policy engine 11 applies rule 2 and infers that the log action must be performed.

Policy engine 11 runs the logging module to log the incident.

Policy engine 11 applies rule 3 and infers that the notification action must be performed.

Policy engine 11 runs the notification module to notify the sender and administrator.

Policy engine 11 finds that no more rules match, and terminates. As a result the message 5 is not delivered to its recipient and has been blocked.

### THIRD EXAMPLE

### Processing Modules 10:

as first example, plus:
unzipper module, which performs an unzip action of unzipping a zipped file.
Initial Facts:
1: the delivery module can perform the deliver action;
2: the virus scanner module can perform the scan action;
3: the virus scanner module requires the unzipper module to be run first;
4: the unzipper module requires the splitter module to be run first;
5: the unzipper module can perform the unzip action; and
6: the notification module can perform the notification action.

### Rules:

Rule 1 as first example.

When the message processing system 1 receives a message 5 having an attachment which contains a virus, this causes the following sequence of operation:

Policy engine 11 analyses the rules and facts, and infers that the splitter module must be run.

Policy engine 11 runs the splitter module. This creates new facts: a list of the attachments found in the message 5; and one of the attachments is a zipped file. The attachments themselves are written to temporary storage.

Policy engine 11 analyses the rules and facts, and infers that the unzipper module must be run.

The Policy engine 11 invokes the unzipper module to unzip the zipped attachment into temporary storage and create facts: a list of the contents of the zipped attachments.

Policy engine 11 analyses the rules and facts, and infers that the virus scanner module must be run.

Policy engine 11 runs the virus scanner module. This analyses the attachments in temporary storage. The virus scanner module finds a virus and generates a fact accordingly.

Policy engine 11 finds that no more rules match, and terminates. As a result the message 5 is not delivered to its recipient and has been blocked.

### FOURTH EXAMPLE

### Processing Modules 10:

as first example, plus:
spam module, which performs the spam action of analysing message content for spam; and
quarantine module, which performs the quarantine action of sending the message 5 to a quarantine store.

### Initial Facts:

Initial Facts 1 to 3 as first example, plus:
4: the spam scanner module can perform the spam scan action; and
5: the quarantine module can perform the quarantine action.

### Rules:

1: if no virus is present in an attachment to a message 5 and no spam is present in the message content, then deliver the message.
2: if no virus is present in an attachment to a message 5, then perform the spam scan action; and
3: if and only if spam content is present, then perform the quarantine action.

When the message processing system 1 receives a message 5 having attachments which are clean of any virus, but having spam in the message content, this causes the following sequence of operation:

Policy engine 11 analyses the rules and facts, and infers that the splitter module must be run.

Policy engine 11 runs the splitter module. This creates new facts: a list of the attachments found in the message 5. The attachments themselves are written to temporary storage.

Policy engine 11 analyses the rules and facts, and infers that the virus scanner module must be run.

Policy engine 11 runs the virus scanner module. This analyses the attachments in temporary storage. The virus scanner finds no virus and does not generate any facts.

Policy engine 11 applies rule 2, and infers that the spam scan action must be performed.

The Policy engine 11 runs the spam scanner module. Spam is found, and a fact created accordingly.

Policy engine 11 applies rule 3, and infers that the quarantine action must be performed.

The Policy engine 11 runs the quarantine module to quarantine the mail.

Policy engine 11 finds that no more rules match, and terminates. As a result the message 5 is not delivered to its recipient and has been blocked.

Considering the first to fourth examples in order it can be seen that increasingly complex policies are implemented. In practice, much more complex policies than these can be implemented by creating more processing modules 10, facts and rules.

Although the above description relates specifically to a message 5 which is an email, the message processing system 1 is equally applicable to messages 5 of any type which are transmitted over the network 2. The message 5 is the object which is processed by an application at the sender 3 and the recipient 4, rather than a packet of data handled by the communications protocol and into which the message 5 may be divided. For any type of message 5, the basic structure of processing modules 10 which perform actions, facts and rules will be the same, although the nature of the actions, facts and rules will be changed in accordance with the nature of the message 5.

In one alternative, the message 5 is an IM message, for example in the form of an RTF file or an XML file. In this case, both the IM messages themselves and the attachments could be scanned on an intermediate server in which the message processing system 1 is implemented. Typical unacceptable content to detect would be offensive language, confidential information, exploits, and offensive images. Typical actions would be to block, modify, log, or notify as in the case of emails. The main difference from email is that an end-to-end session is set up between two people, and there is no distinct sender or recipient as both can send at any time. Also messages are generally very short, consisting typically of a few words. However, these differences from emails do not affect the underlying structure and operation of the message processing system 1.

In another alternative, the message 5 is a web page, for example being a file in HTML or XHTML format and any embedded files, for example containing scripts or graphics. In this case, the message processing system 1 may be implemented as part of a web scanning system using a proxy server where web pages are stored, scanned and forwarded to the original requester. Typical unacceptable content to detect would be malware, exploits, adverts and offensive images. Typical actions would be to block the page, notify an administrator, modify the web page to remove the content and so on. The main different from the email case is that web pages are delivered in response to a request from the client, rather than in response to a request from the mail sender. However, these differences from emails do not affect the underlying structure and operation of the message processing system 1.

1. A message processing system for processing messages being delivered across a network, the system comprising:
a plurality of processing modules which are each operable to perform an action, the actions performed by the modules including actions of controlling the delivery of a message;
a facts data store storing facts including message facts specifying information about messages, the actions performed by the modules further including actions of analysing a message and generating message facts;
a rules data store storing rules, the rules specifying the performance of actions in dependence on facts in the facts data store;
a policy engine operative to cause the operation of processing modules selectively in accordance with rules in the rules data store and facts in the facts data store on which the rules depend.

2. A message processing system according to claim 1, wherein the facts further include module facts identifying the actions which the modules are operable to perform, and the policy engine is operative to select actions in accordance with the rules in the rules data store and the facts on which the rules depend and to cause operation of modules identified by module facts to perform the selected actions.

3. A message processing system according to claim 2, wherein the actions performed by the modules further include actions of generating the module facts.

4. A message processing system according to claim 2, wherein the module facts further specify the dependencies of the actions performed by different modules.

5. A message processing system according to claim 1, wherein the rules include rules specifying the performance of actions which differ in the case of message facts specifying different delivery attributes of the messages.

6. A message processing system according to claim 5, wherein said delivery attributes include at least one of a recipient of the messages and the sender of the messages.

7. A message processing system according to claim 1, wherein said actions of analysing a message and generating the message facts include actions of extracting content of the headers of messages and generating message facts specifying the extracted content of the headers of messages.

8. A message processing system according to claim 1, wherein said actions of analysing a message and generating the message facts include actions of analysing messages to identify unacceptable content and generating message facts specifying identified unacceptable content of messages.

9. A message processing system according to claim 8, wherein the unacceptable content includes at least one of malware; spam; confidential information; and culturally unacceptable content.

10. A message processing system according to claim 8, wherein the rules include rules specifying the performance of actions of controlling the delivery of a message conditional on message facts specifying identified unacceptable content of that message.

11. A message processing system according to claim 8, wherein the actions performed by the modules further include actions of modifying a message to remove unacceptable content.

12. A message processing system according to claim 11, wherein the rules include rules specifying the performance of actions of modifying a message to remove unacceptable content conditional on message facts specifying identified unacceptable content of that message.

13. A message processing system according to claim 1, wherein the actions performed by the modules further include actions of providing feedback of message facts.

14. A message processing system according to claim 13, wherein said actions of providing feedback of message facts include at least one of: storing logging data of message facts; or generating a new message indicating message facts.

15. A message processing system according to claim 1, wherein the facts further include contextual facts specifying information about the context in which a message is delivered.

16. A message processing system according to claim 15, wherein said information about the context in which a message is delivered includes at least one of the time when a message is delivered; or the environment in which a message exists.

17. A message scanning system according to claim 1, wherein the message scanning system is located at a node of the network through which the messages are delivered.

18. A message scanning system according to claim 1, wherein the messages are emails.

19. A message scanning system according to claim 1, wherein the messages are one of IM messages or web pages.
